(19) United States
(12) Patent Application Publication
(10) Pub. No.: US 2016/0123786 A1
(43) Pub. Date: May 5, 2016

(54) DUAL LID CONTAINER-DISPENSER APPARATUS

(71) Applicants: Paul J. Hanna, Wexford, PA (US); Ronald A. Esposito, JR., Mars, PA (US)

(72) Inventors: Paul J. Hanna, Wexford, PA (US); Ronald A. Esposito, JR., Mars, PA (US)

(73) Assignee: AIP Creations, LLC, Mars, PA (US)

(21) Appl. No.: 14/530,776

(22) Filed: Nov. 2, 2014

(51) Int. Cl. G01F 11/28; B65D 51/18; B65D 47/06

(52) U.S. Cl. CPC G01F 11/282; B65D 47/06; B65D 51/18; B65D 2251/0028; B65D 2251/0056; B65D 2251/009

(57) ABSTRACT

A container-dispenser (100) with bipartite lids, each lid (10) having an upper lid (10a) with a port (20) or coupling spout (10d), and a lower lid (10b) that couples the lid to the container (30). Upper and lower lids rotate independently of one another. The upper lid underside has protruding chamber seals (60). The container body (30) features one or more storage chambers (30a) formed by fixed or removable walls (40), mating channels (30b 30d 30f) for the walls, a conical base (30i), and a center post (30c) rising out of the base. The base separates the chamber area from a storage space (30e) housing a funnel (50) with a truncated threaded neck. To use, the lid having a spout is coupled to the top of the container body, the upper lid rotated until the spout is directly over the desired chamber. The funnel and spout are coupled prior to filling a chamber with powder. Powder is dispensed through the spout minus the funnel.

### TECHNICAL FIELD

The invention pertains to the field of containers and dispensers for quantities of food. More particularly, the invention pertains to the field of combined container-dispenser apparatuses designed to store, organize, dispense, and transport quantities of food, particularly powdered foods.

### BACKGROUND OF THE INVENTION

Travel has always created inconvenience, but in particular, those who travel frequently are constantly subject to difficult transportation options with respect to supplements or pre-measured foods. Vitamins and other small pills are easily organized, stored, and transported in pill containers, but no easy solution exists for powder supplements, such as whey protein drink mixes, powdered vitamin drinks, baby formula, ground coffee, etc. When a single powder supplement is used, a traveler will place a quantity of powder into a plastic bag or container, and then pack a measuring scoop or spoon, a drink container into which the powder is dispensed, and a stirring tool such as a whisk for mixing the powder. The main problem with this solution is its inconvenience, and premeasuring and preparing multiple small bags or loose containers so as to eliminate the measuring utensil is tedious and bulky.

When multiple powders are used, organizing, packing, and mixing the powders becomes even more difficult: separate containers and separate scoops must be packed, labelled, and organized as there is no universal or standard amount of powder for any given supplement—so one brand of supplement may have its own scoop and a different brand may use a completely different scoop, and the powder containers and measuring scoops must be identified and kept organized. Further, whether a traveler takes a single powder or multiple powders, the powders must be mixed with a source of liquid, and for many travelers, bottled water is the only reliable and readily available clean source of potable water. The water bottle lid also allows the traveler to mix the powder by shaking the bottle's contents, eliminating the need for a mixing tool. However, since powders are generally messy to measure, dispense, and mix even when using a cup, when the bottle of water is the only liquid container that can be used for mixing the powder, unless the traveler remembered to bring a funnel, measuring and then dispensing the powder cleanly and completely into the bottle of water is a hassle. In particular, the combination of a tall, thin water bottle and a wobbly funnel inserted into, but not securely attached to the bottle, creates spillage opportunities.

Even if the traveler is very organized and can remember all the measuring scoops, amounts, etc., using plastic bags or disposable containers are not always a good option for storing and transporting multiple powders, since bags can rip and common plastic containers stored in a suitcase are subject to abuse during travel and may crack or spill powder. Bags or containers can also get lost, so the traveler must scrupulously count and organize the multiple bags or containers to ensure a dose is not missing.

What is needed is a container that can safely and conveniently transport premeasured quantities of powder or other foods and keep quantities of stored powders or other foods separate from one another.

What is also needed is an easy to use dispenser that allows convenient dispensing of powder from the container into a conventional water bottle, and cleanly dispenses other foods.

### DISCLOSURE OF THE INVENTION

Accordingly, in a first aspect of the invention, an apparatus for storing and dispensing a quantity of material is comprised of a container body having a top and a bottom adapted to couple with a first lid comprised of a spout on a top side of the first lid, and a chamber seal on an underside of the first lid. The container body further houses a chamber for storing the quantity of material, the stored quantity of material accessed through the top of the container body via an aperture formed in the first lid that is covered by the spout. The spout further formed with mating means for removably coupling with a funnel having mating means formed on a funnel neck.

Still in a first aspect of the invention, a second lid having a port on a top side of the second lid and a chamber seal on an underside of the second lid is adapted to couple with at least one of the top and the bottom of the container body. When the first lid is coupled to the top of the container body, the first lid is a functional lid of the invention, allowing the quantity of material to be stored or dispensed, and the second lid typically is coupled to the bottom of the container body. When the second lid is coupled to the top of the container body, the second lid is the functional lid of the invention, and the first lid is coupled to the bottom of the container body.

In a second aspect of the invention, the first lid and the second lid are further comprised of an upper lid and a lower lid. The upper lid is coupled to the lower lid so as to allow the upper lid to rotate independently of the lower lid when the lower lid is removably coupled to at least one of the top and the bottom of the container body.

In a third aspect of the invention, the container body is further comprised of a base with a center post affixed to the base, the base affixed to a container interior wall such that the base and affixed center post define the chamber and a storage space beneath the base housed inside the container body. The storage space is sized and shaped to receive the funnel.

In a fourth aspect of the invention, at least two walls positioned inside the chamber are provided, the walls affixed to at least one of the center post, the base, and the container interior wall so as to create a second chamber housed inside the container body. In some embodiments, the at least two walls are permanently affixed to at least one of the center post, the base, and the container interior wall. In other embodiments, the center post, the base, and the container interior wall are further comprised of receiving means sized and shaped to removably receive the at least two walls.

In a fifth aspect of the invention, the chamber seal is further formed so as to protrude into the chamber when the first lid or the second lid is mated with the top of the container body. In some embodiments, two or more chamber seals are provided, each chamber seal held in spaced apart relationship from another chamber seal by chamfered walls formed into each chamber seal separated by a valley formed between the chamfered walls. When the first lid or the second lid is coupled to the top of the container body, and there are two or more chambers housed inside the container body, a top of each wall defining the chambers is positioned in the valley between each chamber seal, thereby sealing the contents of each chamber and preventing cross contamination of the quantity of material stored in each chamber.

In a sixth aspect of the invention, the center post is formed with a blind hole sized and shaped to receive a pen whereby the pen is stored at least partially inside the blind hole.

In a seventh aspect of the invention, the funnel neck is further comprised of a through-hole and the mating means are formed on an exterior perimeter of the funnel neck, and wherein the mating means of the spout are formed on an interior perimeter of the spout.

In an eighth aspect of the invention, at least one of the container body and the lid is made of a BPA-free plastic.

### BRIEF DESCRIPTION OF THE DRAWINGS

The features and advantages of the invention will become apparent from a consideration of the subsequent detailed description presented in connection with accompanying drawings, in which:

FIG. 1A is an exploded side elevation view of a dual lid container and dispenser according to the invention.

FIG. 1B is a perspective view with a partial cutaway of the dual lid container and dispenser shown in FIG. 1A.

FIG. 1C is a side elevation view of the dual lid container and dispenser of FIG. 1B, showing a cross section of the container body, including a storage space for storing a funnel beneath a base.

FIGS. 2A-C are three top views of an interior space of the container body, FIGS. 2A-B showing an adjustable chamber space using removable walls, and FIG. 2C shows a multi-chambered container body, with adjustable or fixed walls.

FIG. 3 is a perspective view of a lid with a spout and a flip top lid covering a port according to the invention.

FIG. 4A is a perspective view of the lid with the spout shown in a storage position.

FIG. 4B is a perspective view of a lid with a port with the flip top shown in a dispensing position.

FIG. 5A is a perspective view of an underside of the lid shown in FIGS. 4A and 6.

FIG. 5B is a side elevation view of the lid in FIGS. 4A-B.

FIG. 5C is a perspective view of an underside of the lid shown in FIG. 4B.

FIG. 6 is a perspective view of the funnel and the lid in FIG. 4A, showing how the funnel engages the spout when the spout is in a dispensing position.

### DRAWINGS LIST OF REFERENCE NUMERALS

The following is a list of reference labels used in the drawings to label components of different embodiments of the invention, and the names of the indicated components.
100 dual lid container and dispenser apparatus lid
10a upper lid
10b lower lid
10bb threads on lower lid
10c space or gap
10d spout
10e threads (on spout)
10f aperture
20 port
20a flip top
30 container body
30a chamber
30b wall channel
30c center post
30d post channel
30e funnel storage space
30f receiving means (channel or furrow)
30g threads on container body
30h interior cylindrical wall of container body
30i base
40 wall
40a angled wall bottom
50 funnel
50a threads
50b neck
60 chamber seals
60a chamfered wall
60b valley
70 writing implement or pen

### DETAILED DESCRIPTION

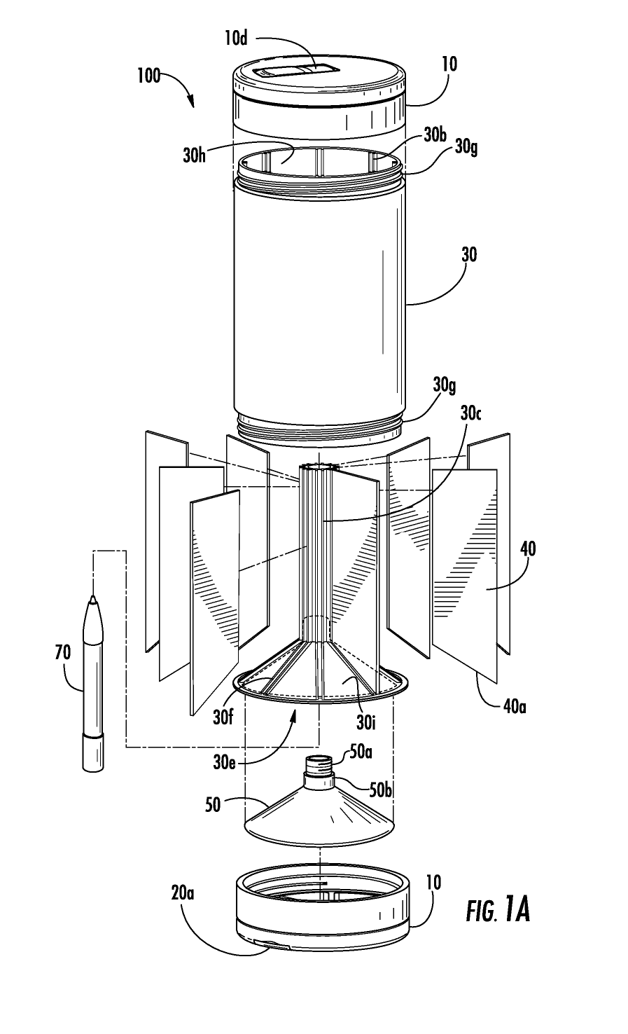

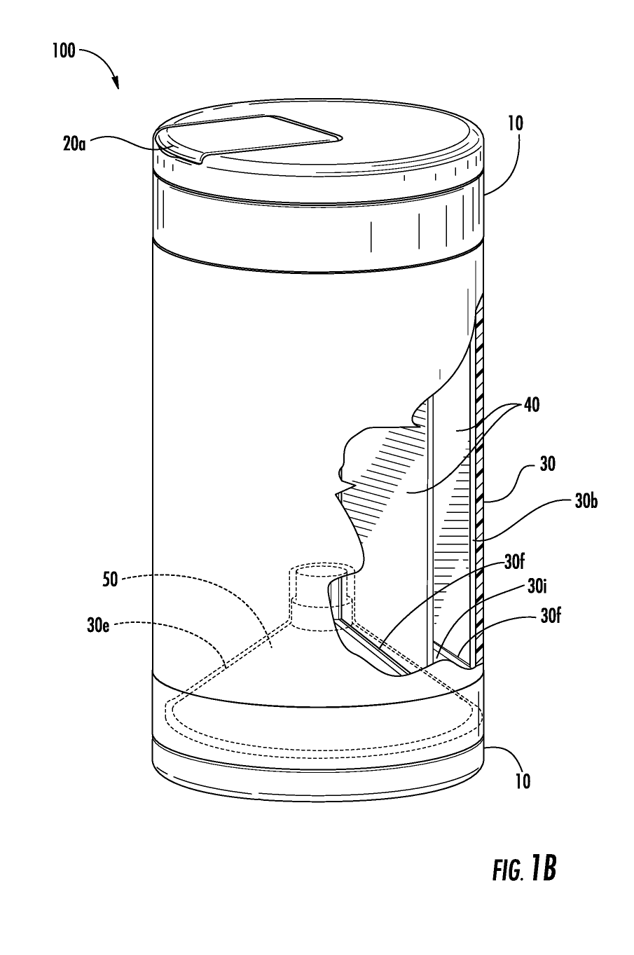

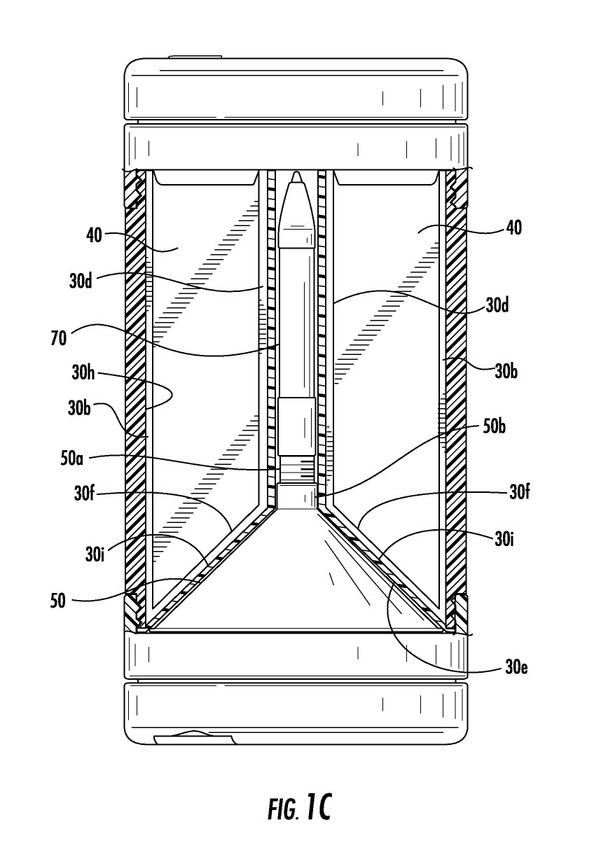

The invention 100 is an improved dual lid compartmentalized container described below and in FIGS. 1-6.

The invention allows dietary supplements, in powdered form or apportioned or pieced, such as pills, to be easily and safely transported, stored, organized and dispensed. The term “dietary supplements” is meant to include any edible form of powder, pills or small foods such as nuts, candy, granola, and even ground coffee and dried herbs. The invention protects the dietary supplements during transportation since the container body is designed to withstand moderate impact and physical abuse that potentially occurs during travel conditions.

The inventors note that the invention's primary function is the transportation, storage, organization, separation and dispensing of various powders into the small openings of bottles (i.e. water bottles) where the normal methods of scooping powder from one container to another is either undesirable or not practical.

Turning now to the Figures, the invention 100 is comprised of a cylindrical container body 30 having an array of threads 30g formed into the container body walls at a top and a bottom of the container body 30. The container body 30 is comprised of an adjustable chamber 30a, the chamber 30a defined by a cylindrical interior wall 30h of the container body, an opening at the top of the container body 30 and a base 30i defined by a continuous sloped wall, the base resembling an inverted cone with an affixed center post 30c rising from an apex of the cone through the chamber 30a and to the top of the container body.

In a typical embodiment having at least one removable internal wall 40, the interior container wall 30h is further comprised of at least one wall channel 30b, in the Figures shown as a pair of relatively short, raised walls in parallel, spaced apart relationship. Opposite the wall channel 30b and formed along the center post 30c is a post channel 30d having a pair of parallel raised walls similar in size and shape as the those of the opposed wall channel 30b, and a same spaced apart relationship as that of the oppose wall channel 30b.

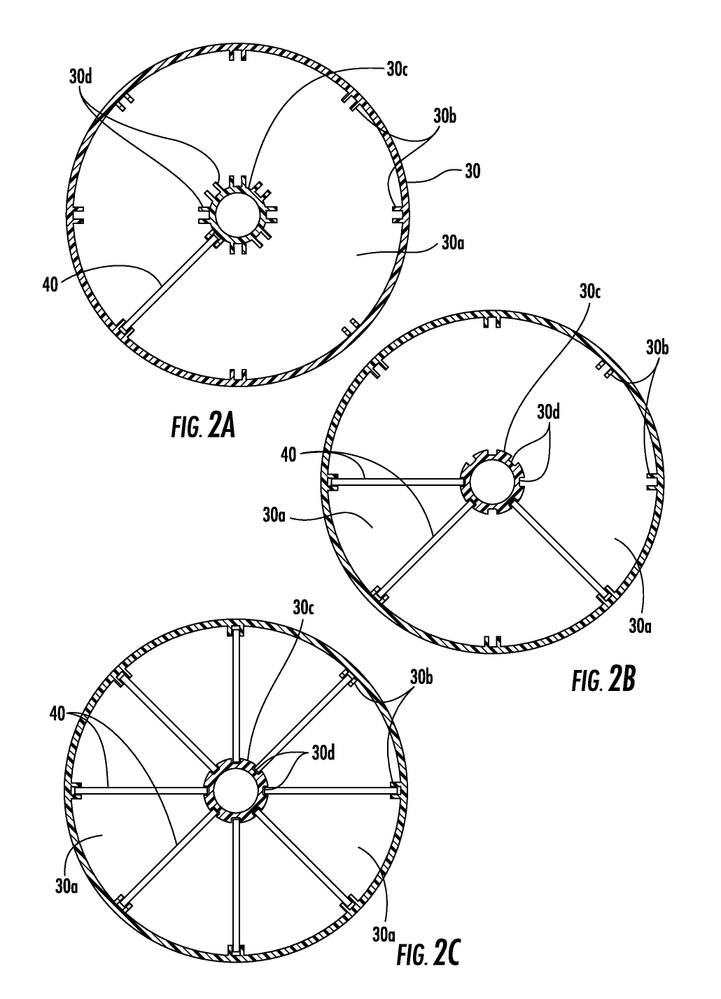

Turning to the Figures, in FIGS. 2A-B, the chamber 30a is shown having differing configurations of internal walls 40. In FIG. 2C, in one embodiment, the container body 30 is divided into eight individually separated chambers that are fixed, or customizable, and in other embodiments consistent with FIGS. 2A-B, the walls 40 can be removably inserted into the wall channels and the post channels so as to form a total of eight chambers, but by removing three walls 40, for instance, five chambers 30a are created and so on. Any variation or array from one large chamber (no walls) to a total of eight chambers (eight walls) is possible.

In the embodiments shown that provide removable walls 40, the sloped walls forming the base 30i are further formed with a channel or furrow 30f to receive an angled wall bottom 40a of the wall 40. The channels 30b 30d 30f prevent powder from one chamber leaking into an adjoining chamber. The chambers 30a allow for the convenient separation and organization of dietary supplements, and allow a single container to both powdered supplements and apportioned supplements such as pills, but in separate chambers. It should be noted that the walls 40, post channels 30d, and wall channels 30b span the entire length of the chamber 30a, from the base 30i to the an uppermost edge of the container body 30, as shown in FIG. 1A. This configuration prevents stored dietary supplements in one chamber 30a from spilling or cross contaminating stored dietary supplements in another chamber 30a.

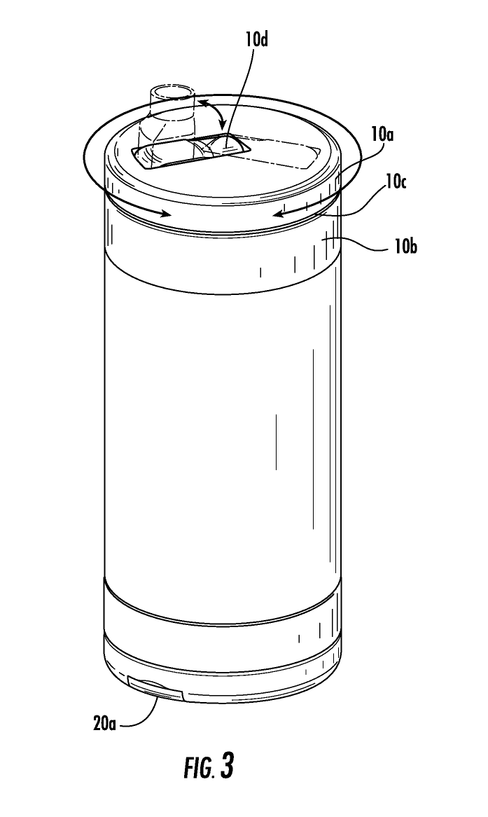

Turning now to FIGS. 3-5C, the invention provides for a pair of lids 10, each lid identical to the other except for the presence of a spout 10d on a first lid (FIGS. 3,4A) and a port 20 with a flip top 20a on a second lid (FIG. 1B,4B). Each lid 10 is further comprised of an upper lid 10a into which the spout 10d or the port 20 and the flip top 20a is affixed, and a lower lid 10b having mating means, typically threads 10bb formed along an interior perimeter, the threads 10bb mating with the array of threads 30g formed along the top and the bottom of the container body 30. Either lid can be screwed onto or mated with the top or the bottom of the container body 30, but the lid mated to the top of the container body, allowing access to the chamber 30a, is a current functioning lid, and can be either the lid having the spout or the lid having the port and flip top. The inventors believe that complementary threaded mating structures are the most convenient way in which to secure the lids to the container body, however the threads are just a typical example of mating structure suitable for the invention and are not meant to limit the mating of the lid to the container body to just mating threads. Pressure seals formed along the interior perimeter of the lids for instance, could also be used, where coupling consists of forcing the lid onto the relevant top or bottom of the container body, and where the seals and the container body deform so as to permit coupling of the lid to the container body. Clamps formed on the lid can also be used to secure the lid onto the container body, as well as other variations of mating threads that consist of locking the lid to the container body by turning and engaging mating parts.

The upper and the lower lids are held in spaced apart relationship by a space or gap 10c, allowing the upper lid 10a to rotate freely and independently of the lower lid 10b while the lower lid 10b is secured to the container. It should be noted that in the Figures, the size of the gap 10c is for illustration purposes only, to show that the lids are separate, and in other embodiments, the gap 10c also encompasses adjacent lower and upper lids. The lower lid secures the lid 10 to the container body 30, while the upper lid 10a is rotatably coupled to the lower lid 10b.

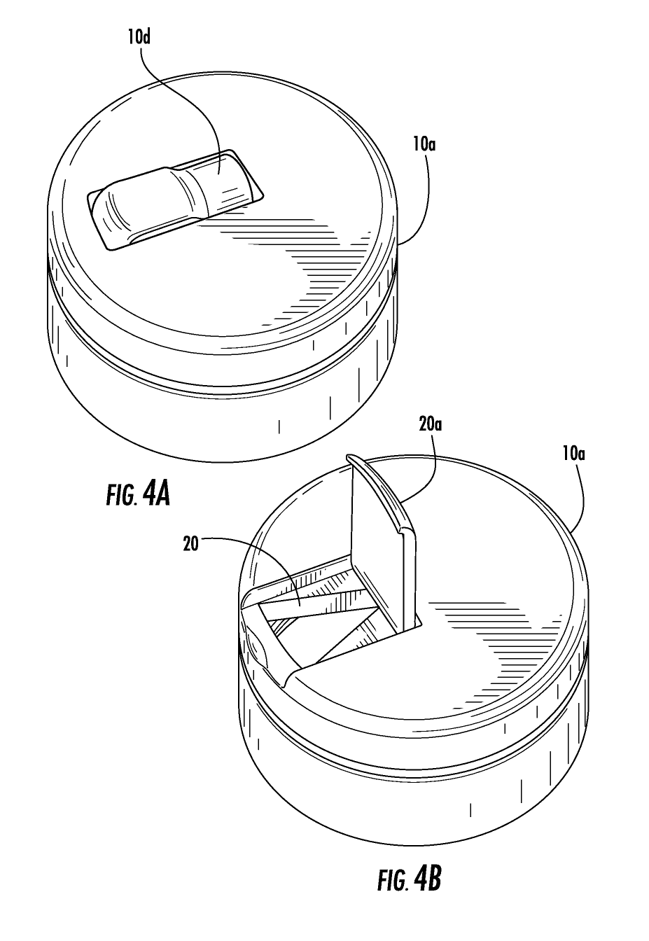

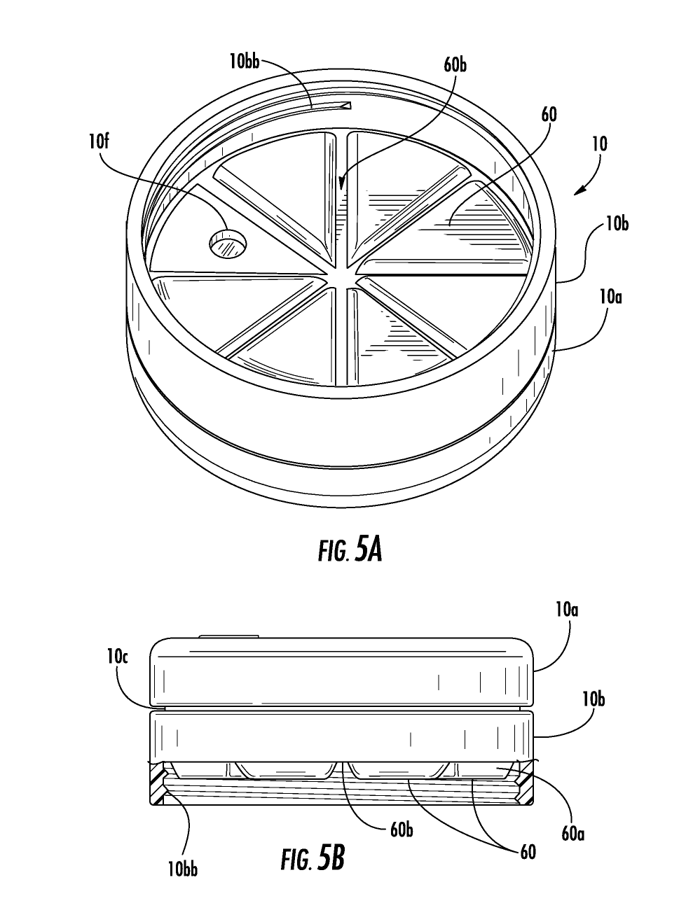

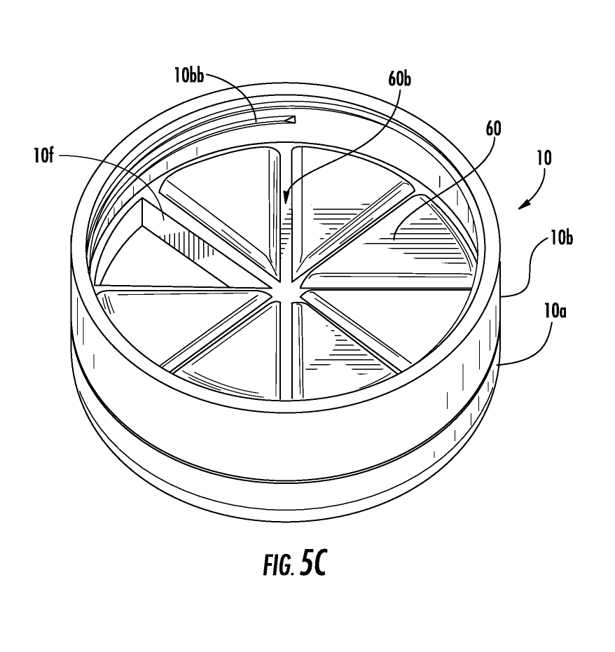

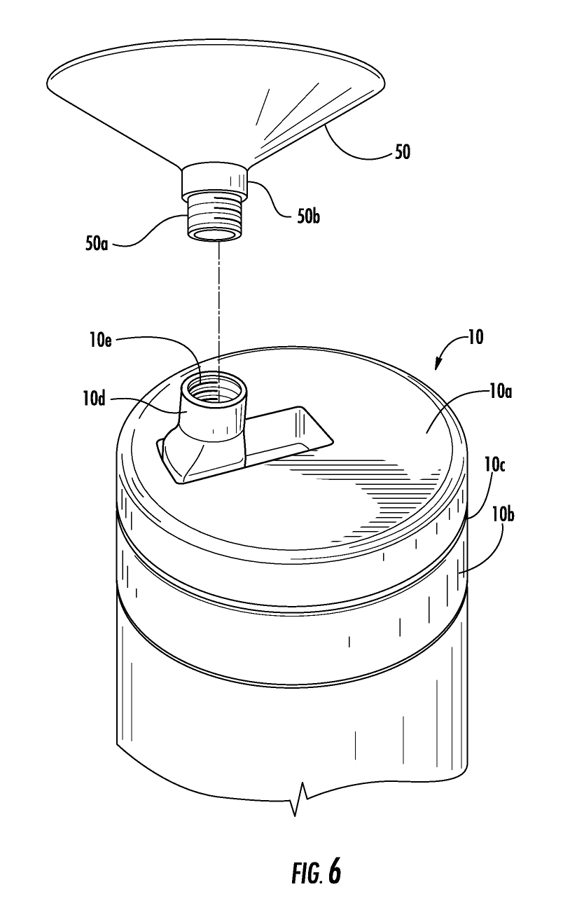

Turning now to FIGS. 4A-B, and FIGS. 5A-C, the upper lid 10a on a top side is formed with either the spout 10d or the port 20, but on an underside of the upper lid 10a (FIG. 5A) a plurality of chamber seals 60 protrude from the underside of the upper lid 10a, and an opening for the spout 10d is shown as an aperture 10f. In a typical embodiment, the chamber seals 60 are defined by chamfered walls 60a and each chamber seal is separated from another by valleys 60b sized and shaped to correspond with the walls 40 defining the chambers 30a, such that when the lid 10 is secured to the top of the container body, the chamber seals 60 seat down into the chamber 30a, and a top of each wall 40 lodges securely into a valley 60b, thus sealing the chamber contents therein. It should be noted that the chamber seals 60 extend almost all the way to the junction of where a flat portion of the upper lid meets a vertical wall that is itself rotatably affixed to the lower lid, as shown in the Figures, so as to allow the chamber seal 60 to completely and effectively seal off the chamber and its contents. When the lid is comprised of the port 20 and flip top 20a, the aperture 10f on the underside of the upper lid is provided as an opening beneath the flip top 20a that defined by the valley 60b of the immediately adjacent chamber seals 60 and their respective chamfered walls 60a, and thus comprises an entire triangular-shaped area corresponding to the size of a chamber seal directly below the flip top 20a.

When the lid 10 is secured onto the container body 30, a user grasps the upper lid 10a and rotates it a predetermined rotational distance. The chamfered walls 60a allow the chamber seal to move more easily over the top of the wall 40 and then “click” into place over the next chamber 30a, sealing the chamber. It is important to note here that the embodiments show the chamber seal side walls as typically chamfered, beveled, curved, or otherwise shaped along the outer edges to as to reduce friction when turning the upper lid in either direction while still sealing off each chamber. The inventors use the term “chamfered wall” to indicate that the outer edges of the chamber seals are shaped so as to reduce friction when the upper lid is rotated, and is not meant to limit the shape of the chamber seal outer edges as being only chamfered.

Access to any specific chamber is achieved by rotating the spout 10d or port 20 directly over the desired chamber. When the functioning lid is comprised of the port 20, the flip top 20a is flipped open and the container is tilted to allow dispensing of apportioned or pieced dietary supplements such as pills, nuts, granola, and other larger objects. The chamber seals 60 of the lid 10 prevent the contents of the other chambers 30a from being dispensed. Turning to FIG. 5A, the aperture 10f is shown as a through-hole leading directly to an opening in the spout. For both lids, the sloping walls of the chamber seals immediately adjacent the aperture 10f function as a funnel channeling the dietary supplements stored in the respective chamber out of the spout or port and allowing easy dispensing.

When the functioning lid is comprised of the spout 10d, the spout is flipped up and the contents of the chamber directly below the spout can be dispensed through the spout by simply tilting the container body 30. The spout in particular allows for neat and accurate dispensing of dietary supplements in powdered form into a small opening, such as a mouth of a water bottle.

The lid 10 secured onto the bottom of the container body 30 covers and removal therewith allows access to a funnel 50 housed in a storage space 30e formed by the conical base 30i. The center post 30c at its lowermost end affixed to the apex of the conical base is adapted to receive a neck 50b of the funnel 50, either by a blind hole formed in a portion of the center post 30c or, as in some embodiments, the center post 30c is at least in part a hollow tube adapted to receive both the neck and a writing implement or pen 70. The neck 50b is further formed with mating means, typically threads 50a adapted to couple with threads 10e formed on an interior perimeter of the spout. The mating structures 10e 50a of the spout and funnel allow the funnel to be secured to the container, and thus the neck of the funnel can be shortened significantly and yet be both functional and secure inside the spout. The spout itself, with its inner threads, when mated with the funnel neck, becomes an extension of the funnel neck, and thus eliminates the need for the relatively long neck found on conventional funnels, the long neck providing stability when powder or other materials are poured into the conical material collection portion of the funnel. The inventors have thus apportioned the funnel neck length so as to be shared between the spout and the funnel, and by doing so have created a separate, functional spout and a secure funnel that can neatly and accurately store into the chamber, or dispense out of the chamber, the powdered supplements. It should be noted that the only time the funnel is used is to fill the chambers, and when not in use, the funnel is conveniently stored inside the container body, beneath the chamber portion in the storage space. The spout is used to dispense powder from the chambers.

The inventors have noted through personal experience that water bottles, purchased prefilled, or reusable and self-filled, are convenient containers into which powdered supplements may be dispensed, mixed, and then ingested. They have noted however that trying to pour powdered supplements into a small water bottle neck is difficult because powder is difficult to pour and control, and measuring utensils such as scoops are not designed for pouring powders into narrow openings. Hence, the invention 100 allows the user to quickly and conveniently premeasure, store, and dispense powdered supplements by first removing the lid on the bottom of the container body, removing the funnel, and in some embodiments, the optional pen 70, and then securely couple the funnel neck to the spout via the threads 10e 50a. A scoop of other measuring utensil can easily be used to then pour a premeasured quantity of powdered supplement into the funnel and thus into the chamber 30a. Individual chambers can be filled with different powders, or the same powder but of varying amounts, etc. as desired by turning the top portion of the lid to the desired chamber. When the chambers are filled, in some embodiments, the pen is used to write directly onto the container, to indicate a time to ingest the powder, days of the week, identification of powder itself, etc. Once the funnel 50 and in some embodiments, the pen 70 are stored again inside the storage area 30e and the lid is replaced, securing the funnel and pen. The invention 100 thus allows the user to easily organize, store, and then dispense powders and other foods, based on the lid selected. Threads 10e 50a on the inner perimeter of the spout and the outer perimeter of the neck 50b prevent residual powder from spilling when the funnel 50 is uncoupled from the spout 10d, and keeps the threads 10e 50a clean and residue-free.

The container body 30a is typically made of a transparent or translucent BPA-free plastic, to allow users visual ease in identifying chamber contents. The container walls 30h may also be provided with an area that allows personalization of each chamber, to help the user identify the contents therein. In some embodiments, the lids 10 will allow for identification of contents, or feature numbers, days of the week, etc. so as to allow the user a further visual reminder of contents, dosage, and other pertinent information. The container body 30 is sized and shaped to comfortably fit into an average sized hand, and conveniently store into cup holders or in carry-on luggage. The container height, in a typical embodiment, is approximately 6-8 inches, but the inventors note that many different sizes are possible. A diameter of the container body, in a typical embodiment, is approximately 4 inches, but again, a variety of diameters may be suitable.

The inventors note that the channels 30b 30d 30f are shown in the Figures as either raised walls with a centralized slot adapted to receive a side of the wall 40, or as grooves or furrows adapted to receive the side of the wall, and channels, grooves, or furrows can be provided interchangeably on the container walls 30h, center post 30c, and base 30i. The idea behind the groove, furrow, or channel is to provide a way for the side of the wall to mate with the container wall, center post, and base so as to create a spill-proof chamber.

It is to be understood that the above-described arrangements are only illustrative of the application of the principles of the present invention. Numerous modifications and alternative arrangements may be devised by those skilled in the art without departing from the scope of the present invention. For instance, the inventors note that the two-piece lid described above can be made in a variety of ways to allow the lower lid to secure the entire lid structure onto the container body and yet allow the upper lid to rotate. For instance, a rim or flange may be formed inside the perimeter of both lower and upper lids, with the rim or flange of one lid resting atop the rim or flange of the other. This sort of arrangement is already present on a number of portable coffee mug lids with rotating open/close ports to allow the user to drink the beverage or close the drinking port by rotating a lid over the opening. Many other two-piece lids are known in the art, and the inventors believe that many existing two-piece lid mechanisms can be used with their invention, so long as the lids incorporate the chamber seals described above.

It should also be noted that while the inventors wish to maximize chamber space for storing dietary supplements, and thus the walls feature an angled bottom wall that form the base of the container that in turn forms a funnel-shaped storage area immediately below the chambers, the base does not necessarily have to be funnel shaped, and a non-angled wall and thus a flat base would result in a cylindrical or other shaped storage area beneath the base that would allow extra room for storing other miscellaneous items, and thus is consistent with the inventors' invention and the concept of providing storage space below the chambers.

What is claimed is:

1. An apparatus (100) for storing and dispensing a quantity of dietary supplements, the apparatus comprising:
a container body (30) having a top and a bottom;
a chamber (30a) housed inside the container body;
a lid (10) having a spout (10d) formed on a topside of the lid and a chamber seal (60) formed on an underside of the lid, the lid selected to couple with at least one of the top and the bottom of the container body; and
a funnel (50);
wherein the funnel (50) is removably coupled to the spout (10d); and
wherein the chamber (30a) is accessed through the top of the container body (30).

2. The lid of claim 1, further comprising:
an upper lid (10b), and
a lower lid (10b);
wherein the upper lid (10b) is coupled to the lower lid (10b) so as to allow the upper lid to rotate independently of the lower lid; and
wherein the upper lid (10a) further comprises an aperture (10f) covered by the spout (10d).

3. The apparatus of claim 2, further comprising a second lid (10) having a port (20) and a chamber seal (60) formed on an underside of the second lid, the second lid selected to couple with at least one of the top and the bottom of the container body.

4. The apparatus of claim 1, wherein the chamber seal (60) is further comprised of a chamfered wall (60a).

5. The apparatus of claim 1, wherein the container body (30) further comprises a base (30i) and a center post (30c) affixed to the base (30i) and wherein the base is affixed to a container interior wall (30h), the base and the center post both defining the chamber (30a) and a storage space (30e) below the base and housed inside the container body.

6. The apparatus of claim 5, wherein the storage space (30e) is sized and shaped to receive the funnel (50).

7. The apparatus of claim 5, further comprising at least two walls (40) positioned inside the chamber (30a), each wall affixed to at least one of the center post (30c), the base, and the container interior wall (30h), whereby inclusion of at least two walls creates a second chamber housed inside the container body.

8. The apparatus of claim 7, wherein the at least two walls are permanently affixed to the center post (30c) and to the base (30i).

9. The apparatus of claim 7, wherein the center post (30c) and the container interior wall (30h) are further comprised of receiving means (30d 30b) sized and shaped to removably receive the at least two walls.

10. The apparatus of claim 5, wherein the center post is formed with a blind hole sized and shaped to receive a pen (70), whereby the pen is stored at least partially inside the blind hole.

11. The apparatus of claim 1, wherein the funnel (50) further comprises a neck (50b) having a through-hole, and coupling means (50a) formed on an exterior perimeter of the neck, and wherein the spout (10d) further comprises coupling means (10e) formed along an interior perimeter of the spout, whereby the spout and the funnel are removably affixed by mating the coupling means of the funnel and of the spout.

12. A lid (10) for a container having a storage chamber (30a), the lid comprising:
an upper lid (10a) having an underside and a top side;
a lower lid (10b) having an interior perimeter with an array of coupling means (10bb); and
a chamber seal (60);
wherein the upper lid is further comprised of an aperture (10f);
wherein the chamber seal is positioned on the underside of the upper lid (10a); and
wherein the upper lid (10a) is independently rotatable from the lower lid (10b),
whereby securing the lid on the container causes the chamber seal to protrude into the storage chamber (30a) thereby sealing the chamber.

13. The lid (10) of claim 12, further comprising at least one of a spout (10d) and a port (20), wherein the at least one of the spout and the port covers the aperture (10f) formed in the upper lid (10a).

14. The lid (10) of claim 13, wherein the spout (10d) is further provided with mating means (10e) selected to mate with a funnel (50) having compatible mating means (50a).

15. The lid (10) of claim 12, wherein the chamber seal (60) is further comprised of a chamfered wall (60a).

16. The lid (10) of claim 12, wherein two or more chamber seals (60) are provided on the underside of the upper lid (10a), and wherein the two or more chamber seals (60) are held in spaced apart relationship by a valley (60b) formed by between each chamber seal.

17. The apparatus of claim 1, wherein at least one of the container body and the lid is made of a BPA-free plastic.
